(19) United States
(12) Patent Application Publication
(10) Pub. No.: US 2018/0103320 A1
(43) Pub. Date: Apr. 12, 2018

(54) ELECTRONIC DEVICE AND METHOD FOR RECOGNIZING EARPHONE PLUG IN ELECTRONIC DEVICE

(71) Applicant: Samsung Electronics Co., Ltd, Suwon-si (KR)

(72) Inventor: Seok-Weon Kim, Suwon-si (KR)

(21) Appl. No.: 15/726,159

(22) Filed: Oct. 5, 2017

(30) Foreign Application Priority Data
Oct. 7, 2016 (KR) 10-2016-0129865

(51) Int. Cl. H04R 5/033

(52) U.S. Cl. CPC H04R 5/033

(57) ABSTRACT

Various exemplary embodiments relating to the recognition of earphones by an electronic device are described. An electronic device may include a connector into which an earphone plug is insertable, an audio module configured to process a sound signal, a first circuit configured to connect the audio module with a first terminal of the earphone plug, a second circuit configured to connect the audio module with a second terminal of the earphone plug, a switch configured to connect the first circuit with the second circuit, and a processor configured to perform control to output a first signal from the audio module through the second circuit when the earphone plug is inserted into the connector and configured to determine a type of the earphone plug inserted into the connector based on whether the output first signal is received by the audio module through the switch and the first circuit.

### CROSS-REFERENCE TO RELATED APPLICATION

This application is related to and claims priority to Korean Patent Application No. 10-2016-0129865, filed on Oct. 7, 2016, the entire content of which is hereby incorporated by reference.

### TECHNICAL FIELD

The present disclosure relates to an electronic device, and a method for recognizing an earphone plug by an electronic device.

### BACKGROUND

With the improved performance of electronic devices (for example, smartphones) in recent years, a user may be provided with multimedia services, such as video and music, without constraints as to time and space. In using a multimedia service, the user may use earphones to prevent an audio signal output from the electronic device from leaking out or to listen more clearly. To this end, the electronic device supports an earphone interface for earphone connection, and the earphone interface may be a 3-pole earphone interface or a 4-pole earphone interface. The electronic device may recognize the type of earphone interface and may transmit and receive a signal corresponding to each type.

### SUMMARY

To address the above-discussed deficiencies, it is a primary object to provide an earphone recognition method which may include an additional circuit, such as a comparator or an Analog-to-Digital Converter (ADC), to recognize an earphone plug in an electronic device, thus complicating the circuit configuration of the device. Further, the additional circuit including the comparator and the ADC may increase the cost of manufacturing the electronic device.

Therefore, various exemplary embodiments of the present disclosure may provide an electronic device capable of recognizing an earphone plug with a simple circuit configuration, and a method for recognizing an earphone plug by the electronic device.

Further, various exemplary embodiments may provide an electronic device capable of recognizing an earphone plug by adding a switch, and a method for recognizing an earphone plug by the electronic device.

According to various exemplary embodiments, an electronic device may include a connector into which an earphone plug is insertable, an audio module configured to process a sound signal, a first circuit configured to connect the audio module with a first terminal of the earphone plug, a second circuit configured to connect the audio module with a second terminal of the earphone plug, a switch that connects the first circuit with the second circuit, and a processor configured to perform control to output a first signal from the audio module through the second circuit when the earphone plug is inserted into the connector, and configured to determine a type of the earphone plug inserted into the connector based on whether the output first signal is received by the audio module through the switch and the first circuit.

According to various exemplary embodiments, a method for recognizing an earphone plug by an electronic device may include connecting a first circuit, which connects an audio module with a first terminal of an earphone plug, with a second circuit, which connects the audio module with a second terminal of the earphone plug, outputting a first signal from the audio module through the second circuit when the earphone plug is inserted into a connector, and determining a type of the earphone plug inserted into the connector based on whether the output first signal is received by the audio module through a switch and the first circuit.

According to various exemplary embodiments, a storage medium stores an earphone plug recognition program, wherein the program is configured to perform, in an electronic device, connecting a first circuit, which connects an audio module with a first terminal of an earphone plug, with a second circuit, which connects the audio module with a second terminal of the earphone plug, outputting a first signal from the audio module through the second circuit when the earphone plug is inserted into a connector, and determining a type of the earphone plug inserted into the connector based on whether the output first signal is received by the audio module through a switch and the first circuit.

According to various exemplary embodiments of the present disclosure, a circuit configuration makes it possible to recognize whether a connected earphone plug is a 3-pole earphone plug or a 4-pole earphone plug, thereby facilitating the manufacture of an electronic device.

Further, according to various exemplary embodiments, using a switch makes it possible to recognize whether a connected earphone plug is a 3-pole earphone plug or a 4-pole earphone plug, thereby reducing the cost of manufacturing an electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a network environment including an electronic device according to various exemplary embodiments of the present disclosure;

FIG. 2 illustrates a block diagram of an electronic device according to various exemplary embodiments;

FIG. 3 illustrates a block diagram of a program module according to various exemplary embodiments;

FIG. 4 illustrates a perspective view of a connected relationship between a connection member of an electronic device and an earphone plug structure according to various exemplary embodiments of the present disclosure;

FIGS. 5A and 5B illustrate an earphone plug structure according to various exemplary embodiments;

FIG. 6 illustrates a block diagram of 3-pole earphones and an electronic device according to various exemplary embodiments;

FIG. 7 illustrates a circuit diagram for explaining the principle whereby, when a 3-pole earphone plug is inserted, an earphone recognition signal output from an EAR SPK L port of an audio module is not received by an EAR MIC port connected through a switch according to various exemplary embodiments;

FIG. 8 illustrates a block diagram of 4-pole earphones and an electronic device according to various exemplary embodiments;

FIG. 9 illustrates a circuit diagram for explaining the principle whereby, when a 4-pole earphone plug is inserted, an earphone recognition signal output from an EAR SPK L port of an audio module is received by an EAR MIC port connected through a switch according to various exemplary embodiments; and

FIG. 10 illustrates a flowchart of an operation of recognizing an earphone plug type according to various exemplary embodiments.

### DETAILED DESCRIPTION

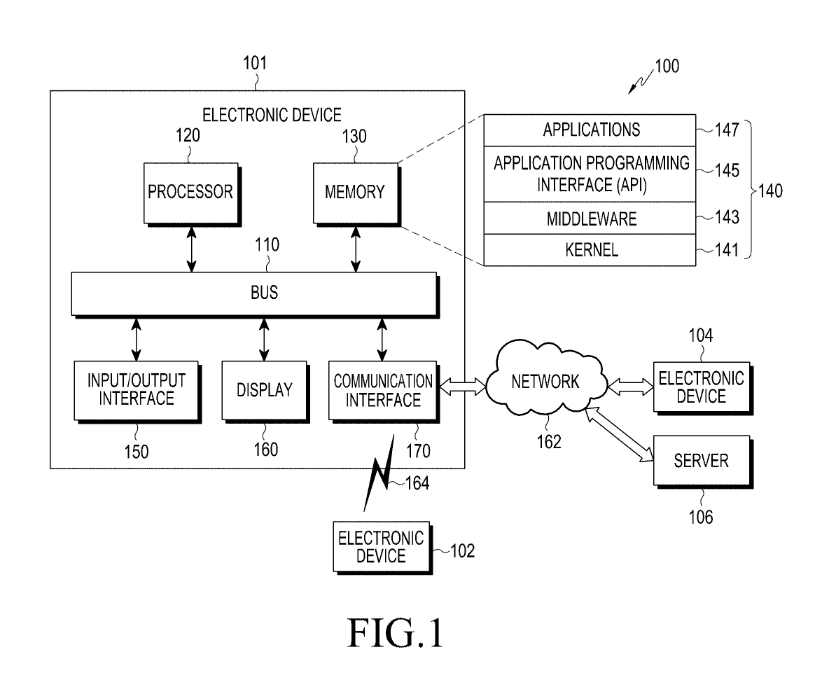

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In the description of the drawings, similar reference numerals may be used to designate similar elements. A singular expression may include a plural expression unless they are definitely different in a context. As used herein, singular forms may include plural forms as well unless the context clearly indicates otherwise. The expression “a first”, “a second”, “the first”, or “the second” used in various embodiments of the present disclosure may modify various components regardless of the order and/or the importance but does not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the present disclosure may be interchangeably used with, for example, “suitable for”, “having the capacity to”, “designed to”, “adapted to”, “made to”, or “capable of” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., Central Processing Unit (CPU) or Application Processor (AP)) that can perform the corresponding operations by executing one or more software programs stored in a memory device.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit). In some embodiments, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR) , a Flight Data Recorder (FDR) , a Vehicle Infotainment Devices, an electronic devices for a ship (e.g., a navigation device for a ship, and a gyro-compass), avionics, security devices, an automotive head unit, a robot for home or industry, an Automatic Teller's Machine (ATM) in banks, Point Of Sales (POS) in a shop, or interne device of things (e.g., a light bulb, various sensors, electric or gas meter, a sprinkler device, a fire alarm, a thermostat, a streetlamp, a toaster, a sporting goods, a hot water tank, a heater, a boiler, etc.). According to some embodiments, an electronic device may include at least one of a part of furniture or a building/structure, an electronic board, an electronic signature receiving device, a projector, and various types of measuring instruments (e.g., a water meter, an electric meter, a gas meter, a radio wave meter, and the like). In various embodiments, the electronic device may be flexible, or may be a combination of one or more of the aforementioned various devices. The electronic device according to one embodiment of the present disclosure is not limited to the above described devices. In the present disclosure, the term “user” may indicate a person using an electronic device or a device (e.g., an artificial intelligence electronic device) using an electronic device.

FIG. 1 illustrates an electronic device 101 in a network environment 100 according to various exemplary embodiments. The electronic device 101 may include a bus 110, a processor 120, a memory 130, an input/output interface 150, a display 160, and a communication interface 170. In some exemplary embodiments, at least one of the components may be omitted, or an additional component may be further included in the electronic device 101. The bus 110 may include a circuit that connects the components 110 to 170 to each other and delivers communications (for example, control messages or data) between the components. The processor 120 may include one or more of a central processing unit, an application processor, and a communication processor (CP). The processor 120 may control, for example, at least one different component of the electronic device 101, and/or may perform an operation relating to communication or data processing.

The memory 130 may include a volatile and/or nonvolatile memory. The memory 130 may store, for example, a command or data related to at least one different component of the electronic device 101. According to one exemplary embodiment, the memory 130 may store software and/or a program 140. The program 140 may include, for example, a kernel 141, middleware 143, an Application Programming Interface (API) 145, and/or an application program (or “application”) 147. At least part of the kernel 141, the middleware 143, and the API 145 may be designated as an operating system. The kernel 141 may control or manage system resources (for example, the bus 110, the processor 120, the memory 130, or the like) used to perform an operation or function implemented in other programs (for example, the middleware 143, the API 145, or the application program 147). Further, the kernel 141 may provide an interface that allows the middleware 143, the API 145, or the application program 147 to access individual components of the electronic device 101 to thereby control or manage system resources.

The middleware 143 may serve as a relay so that, for example, the API 145 or the application program 147 communicates with the kernel 141 to exchange data. Further, the middleware 143 may process one or more requests for operations received from the application program 147 according to priority. For example, the middleware 143 may assign at least one application program 147 a priority for using a system resource (for example, the bus 110, the processor 120, the memory 130, or the like) of the electronic device 101, and may process the one or more requests for operations. The API 145 is an interface for the application program 147 to control a function provided from the kernel 141 or the middleware 143, and may include, for example, at least one interface or function (for example, a command) for file control, window control, image processing, or text control. The input/output interface 150 may deliver a command or data, which is input from, for example, a user or a different external device, to a different component(s) of the electronic device 101 or may output a command or data, which is received from a different component(s) of the electronic device 101, to the user or different external device.

The display 160 may include, for example, a Liquid Crystal Display (LCD), a Light-Emitting Diode (LED) display, an Organic Light-Emitting Diode (OLED) display, a Micro-Electro-Mechanical Systems (MEMS) display, and an electronic paper display. The display 160 may display, for example, various types of content (for example, a text, an image, a video, an icon, a symbol, and/or the like) for the user. The display 160 may include a touch screen and may receive touch, gesture, proximity, or hovering input using, for example, an electronic pen or a body part of a user. The communication interface 170 may establish communication, for example, between the electronic device 101 and an external device (for example, a first external electronic device 102, a second external electronic device 104, or a server 106). For example, the communication interface 170 may be connected to a network 162 via wireless communication or wire-based communication to communicate with the external device (for example, the second external electronic device 104 or the server 106).

The wireless communication may include cellular communication using, for example, at least one of Long-Term Evolution (LTE), LTE-Advanced (LTE-A), code division multiple access (CDMA), wideband CDMA (WCDMA), universal mobile telecommunications system (UMTS), Wireless Broadband (WiBro), and Global System for Mobile Communications (GSM). In one exemplary embodiment, the wireless communication may include, for example, at least one of Wireless Fidelity (Wi-Fi), Bluetooth, Bluetooth Low Energy (BLE), Zigbee, Near Field Communication (NFC), Magnetic Secure Transmission, Radio Frequency (RF), and a Body Area Network (BAN). In one exemplary embodiment, the wireless communication may include a Global Navigation Satellite System (GNSS). The GNSS may be, for example, a Global Positioning System (GPS), a global navigation satellite system (Glonass), a Beidou navigation satellite system (hereinafter, “Beidou”), or Galileo, which is the European global satellite-based navigation system. In the present document, “GPS” may be interchangeably used with “GNSS” hereinafter. The wire-based communication may include, for example, at least one of Universal Serial Bus (USB), High Definition Multimedia Interface (HDMI), Recommended Standard 232 (RS-232), Power Line Communication, and Plain Old Telephone Service (POTS). The network 162 may include a telecommunications network, which may be, for example, at least one of a computer network (for example, a Local Area Network (LAN) or Wide Area Network (WAN)), the Internet, and a telephone network.

The first and second external electronic devices 102 and 104 may each be a device of a type that is the same as, or different from, the electronic device 101. According to various exemplary embodiments, all or part of the operations performed in the electronic device 101 may be performed in another electronic device or a plurality of electronic devices (for example, the electronic devices 102 and 104 or the server 106). According to one exemplary embodiment, when the electronic device 101 needs to perform a function or service automatically or upon request, the electronic device 101 may request another electronic device (for example, the electronic device 102 or 104, or the server 106) to perform at least some functions related to the function or service, instead of, or in addition to, autonomously performing the function or service. The other electronic device (for example, the electronic device 102 or 104, or the server 106) may perform the requested functions or additional function and may transmit the result thereof to the electronic device 101. The electronic device 101 may provide the requested function or service using the same received result or by additionally processing the result. To this end, cloud computing, distributed computing, or client-server computing technologies may be used.

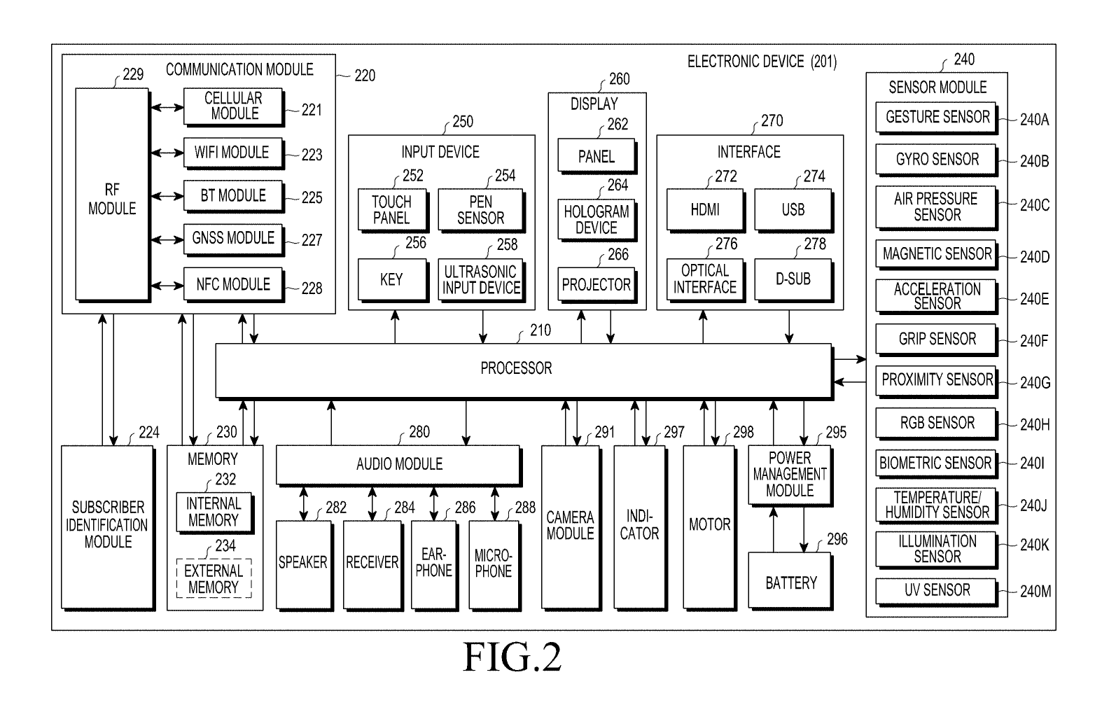

FIG. 2 illustrates a block diagram of an electronic device according to various exemplary embodiments.

The electronic device 201 may include, for example, all or part of the electronic device 101 illustrated in FIG. 1. The electronic device 201 may include one or more processors (for example, Aps) 210, a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298. The processors 210 may run, for example, an operating system or an application program to control a plurality of hardware or software components that are connected to the processors 210 and may perform various kinds of data processing and operations. The processors 210 may be configured, for example, as a System on Chip (SoC). According to one exemplary embodiment, the processors 210 may further include a Graphic Processing Unit (GPU) and/or an image signal processor. The processors 210 may include at least part (for example, a cellular module 221) of the components illustrated in FIG. 2. The processors 210 may load a command or data received from at least one of other components (for example, a nonvolatile memory) into a volatile memory to process the command or data, and may store resulting data in the nonvolatile memory.

The communication module 220 may have a configuration that is the same as, or similar to, that of the communication interface 170. The communication module 220 may include, for example, a cellular module 221, a Wi-Fi module 223, a Bluetooth module 225, a GNSS module 227, an NFC module 228, and an RF module 229. The cellular module 221 may provide, for example, a voice call, a video call, a text messaging service, or an Internet service through a communication network. According to one exemplary embodiment, the cellular module 221 may perform identification and authentication of the electronic device 201 in a communication network using the SIM (for example, a SIM card) 224. According to one exemplary embodiment, the cellular module 221 may perform at least part of the functions provided by the processors 210. According to one exemplary embodiment, the cellular module 221 may include a Communication Processor (CP). According to one exemplary embodiment, at least some (for example, two or more) of the cellular module 221, the Wi-Fi module 223, the Bluetooth module 225, the GNSS module 227, and the NFC module 228 may be included in one Integrated Chip (IC) or IC package. The RF module 229 may transmit and receive, for example, a communication signal (for example, an RF signal). The RF module 229 may include, for example, a transceiver, a Power Amplifier (amp) Module (PAM), a frequency filter, a Low Noise Amplifier (LNA), an antenna, or the like. According to another exemplary embodiment, at least one of the cellular module 221, the Wi-Fi module 223, the Bluetooth module 225, the GNSS module 227, and the NFC module 228 may transmit and receive an RF signal through a separate RF module. The SIM 224 may include, for example, a card including an SIM or an embedded SIM and may include unique identification information (for example, an Integrated Circuit Card Identifier (ICCID)) or subscriber information (for example, an International Mobile Subscriber Identity (IMSI)).

The memory 230 (for example, the memory 130) may include, for example, an internal memory 232 or an external memory 234. The internal memory 232 may include, for example, at least one of a volatile memory (for example, a DRAM, an SRAM, an SDRAM, or the like) and a nonvolatile memory (for example, an OTPROM, a PROM, an EPROM, an EEPROM, a mask ROM, a flash ROM, a flash memory, a hard drive, or a Solid State Drive (SSD)). The external memory 234 may include a flash drive, for example, a Compact Flash (CF), a Secure Digital (SD), a Micro-SD, a Mini-SD, an extreme digital (xD), a Multi-Media Card (MMC), a memory stick, or the like. The external memory 234 may be functionally or physically connected to the electronic device 201 through various interfaces.

The sensor module 240 may measure, for example, physical quantities, or may detect the state of operation of the electronic device 201 and convert measured or detected information into an electrical signal. The sensor module 240 may include, for example, at least one of a gesture sensor 240A, a gyro sensor 240B, a barometric pressure sensor 240C, a magnetic sensor 240D, an accelerometer 240E, a grip sensor 240F, a proximity sensor 240G, a color sensor 240H (for example, a red, green, and blue (RGB) sensor), a biometric sensor 240I, a temperature/humidity sensor 240J, an illumination sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit to control at least one or more sensors belonging thereto. In one exemplary embodiment, the electronic device 201 may further include a processor configured, as part of the processors 210 or separately from the processors 210, to control the sensor module 240, thereby controlling the sensor module 240 while the processors 210 are in a sleep state.

The input device 250 may include, for example, a touch panel 252, a (digital) pen sensor 254, a key 256, or an ultrasonic input device 258. The touch panel 252 may be, for example, at least one of an electrostatic type, a pressure-sensitive type, an infrared type, and an ultrasonic type. Further, the touch panel 252 may further include a control circuit. The touch panel 252 may further include a tactile layer to provide a user with a tactile response. The (digital) pen sensor 254 may, for example, be part of the touch panel or may include a separate recognition sheet. The key 256 may include, for example, a physical button, an optical key, or a keypad. The ultrasonic input device 258 may detect ultrasonic waves generated in an input tool through a microphone (for example, a microphone 288) and may identify data corresponding to the detected ultrasonic waves.

The display 260 (for example, the display 160) may include a panel 262, a hologram device 264, a projector 266, and/or a control circuit to control the panel 262, the hologram device 264, or the projector 266. The panel 262 may be configured, for example, to be flexible, transparent, or wearable. The panel 262 may be formed with the touch panel 252 in one or more modules. According to one exemplary embodiment, the panel 262 may include a pressure sensor (or force sensor) to measure the strength of pressure of a user's touch. The pressure sensor may be formed with the touch panel 252 in a single body, or may be provided as one or more sensors separate from the touch panel 252. The hologram device 264 may display a three-dimensional image in the air using the interference of light. The projector 266 may project light onto a screen to display an image. The screen may be disposed, for example, inside or outside the electronic device 201. The interface 270 may include, for example, an HDMI 272, a USB 274, an optical interface 276, or a D-subminiature (D-sub) interface 278. The interface 270 may be included, for example, in the communication interface 170 illustrated in FIG. 1. Additionally or alternatively, the interface 270 may include, for example, a Mobile High-definition Link (MHL) interface, an SD card/MMC interface, or an Infrared Data Association (IrDA) interface.

The audio module 280 may bidirectionally convert, for example, a sound and an electrical signal. At least some components of the audio module 280 may be included, for example, in the input/output interface 150 illustrated in FIG. 1. The audio module 280 may process sound information input or output, for example, through a speaker 282, a receiver 284, earphones 286, or the microphone 288. The camera module 291 is a device that takes, for example, a still image and a video. According to one exemplary embodiment, the camera module 291 may include one or more image sensors (for example, a front sensor or a rear sensor), a lens, an Image Signal Processor (ISP), or a flash (for example, an LED, a xenon lamp, or the like). The power management module 295 may manage, for example, the power of the electronic device 201. According to one exemplary embodiment, the power management module 295 may include a Power Management Integrated Circuit (PMIC), a charger Integrated Circuit (IC), or a battery or fuel gauge. The PMIC may have wired and/or wireless charging methods. The wireless charging methods may include, for example, a magnetic-resonance method, a magnetic-induction method, or an electromagnetic-wave method, and may further include an additional circuit for wireless charging, such as a coil loop, a resonance circuit, or a rectifier. The battery gauge may measure, for example, the remaining battery charge, the charging voltage, the current, or the temperature of the battery 296. The battery 296 may include, for example, a rechargeable battery and/or a solar battery.

The indicator 297 may display the specific state of the electronic device 201 or a component thereof (for example, the processors 210), which may be, for example, a booting state, a message state, or a charging state. The motor 298 may convert an electrical signal into mechanical vibrations and may generate vibrations or a haptic effect. The electronic device 201 may include a mobile TV support device (for example, a GPU) that is capable of processing media data in accordance with, for example, Digital Multimedia Broadcasting (DMB), Digital Video Broadcasting (DVB), or mediaFlo™ standards. Each element mentioned in the present document may include one or more components, and may be designated by different terms depending on the type of the electronic device. In various exemplary embodiments, an electronic device (for example, the electronic device 201) may be configured such that some elements are omitted, additional elements are further included, or some of the elements are combined into one entity, but may perform the same functions as those of the corresponding elements before combination.

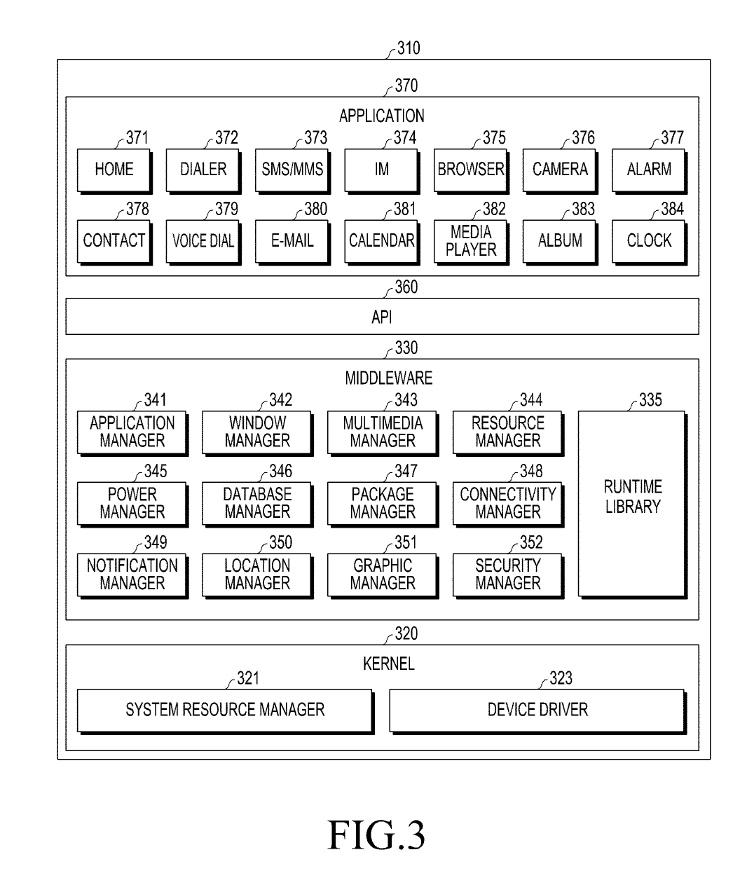

FIG. 3 illustrates a block diagram of a program module according to various exemplary embodiments.

According to one exemplary embodiment, the program module 310 (for example, the program 140) may include an operating system that controls resources related to an electronic device (for example, the electronic device 101) and/or various applications (for example, the application program 147) that run on the operating system. The operating system may include, for example, Android™, iOS™, Windows™, Symbian™, Tizen™, Bada™, or the like. Referring to FIG. 3, the program module 310 may include a kernel 320 (for example, the kernel 141), middleware 330 (for example, the middleware 143), an API 360 (for example, the API 145), and/or an application 370 (for example, the application program 147). At least part of the program module 310 may be preloaded onto the electronic device or may be downloaded from an external electronic device (for example, the electronic device 102 or 104, the server 106, or the like).

The kernel 320 may include, for example, a system resource manager 321 and/or a device driver 323. The system resource manager 321 may perform control, allocation, or recovery of system resources. According to one exemplary embodiment, the system resource manager 321 may include a process manager, a memory manager, or a file system manager. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver. The middleware 330 may provide, for example, functions commonly needed for applications 370, or may provide an application 370 with various functions through the API 360 so that the application 370 may use the limited systems resources in the electronic device. According to one exemplary embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module used by a complier to add a new function through a programming language while the application 370 is running. The runtime library 335 may perform input/output management, memory management, or arithmetic function processing. The application manager 341 may manage, for example, the life cycle of the application 370. The window manager 342 may manage Graphic User Interface (GUI) resources used for a screen. The multimedia manager 343 may identify formats that are used to play media files, and may encode or decode a media file using a codec suitable for a corresponding format. The resource manager 344 may manage a source code or memory space for the application 370. The power manager 345 may manage battery capacity or power supply, and may provide information on power for the operation of the electronic device. According to one exemplary embodiment, the power manager 345 may interwork with a Basic Input/Output System (BIOS). The database manager 346 may generate, retrieve, or change a database to be used for, for example, the application 370. The package manager 347 may install or update an application distributed in the form of a package file.

The connectivity manager 348 may manage, for example, wireless connectivity. The notification manager 349 may provide a user with an event, for example, an incoming message, an appointment, and a proximity notification. The location manager 350 may manage, for example, information about the location of the electronic device. The graphic manager 351 may manage, for example, a graphic effect to be provided for the user or a user interface related to the graphic effect. The security manager 352 may provide, for example, system security or user authentication. According to one exemplary embodiment, the middleware 330 may include a telephony manager to manage a voice or video call function of the electronic device or a middleware module that is capable of forming combinations of functions of the foregoing elements. According to one exemplary embodiment, the middleware 330 may provide a specialized module for each operating system. The middleware 330 may dynamically delete some of the existing elements or add new elements. The API 360 is, for example, a set of API programming functions, and may be provided with a different configuration depending on the operating system. For example, one API set for each platform may be provided in Android or iOS, while two or more API sets for each platform may be provided in Tizen.

The application 370 may include, for example, a home 371, a dialer 372, an SMS/MMS 373, an Instant Message (IM) 374, a browser 375, a camera 376, an alarm 377, a contact 378, a voice dialer 379, an email 380, a calendar 381, a media player 382, an album 383, a watch 384, a health care application (for example, for measuring exercising or blood sugar), or an application providing environmental data (for example, atmospheric pressure, humidity, or temperature data). According to one exemplary embodiment, the application 370 may include an information exchange application that is capable of supporting information exchange between the electronic device and an external electronic device. The information exchange application may include, for example, a notification relay application for relaying specific information to the external electronic device or a device management application for managing the external electronic device. For example, the notification relay application may relay notification information, which is generated in another application of the electronic device, to the external electronic device, or may receive notification information from the external electronic device and provide the notification information to the user. The device management application may install, delete, or update, for example, a function (for example, a function of turning on/turning off the external electronic device itself (or some components) or adjusting the brightness (or resolution) of a display) of an external electronic device communicating with the electronic device or an application operating in the external electronic device. According to one exemplary embodiment, the application 370 may include an application (for example, a health care application of a mobile medical device) assigned according to the attributes of the external electronic device. According to one exemplary embodiment, the application 370 may include an application received from the external electronic device. At least part of the program module 310 may be implemented (for example, run) by software, firmware, hardware (for example, the processor 210), or combinations of at least two or more thereof, and may include a module, a program, a routine, sets of instructions, or a process to perform one or more functions.

According to various exemplary embodiments, an electronic device may include: a connector into which an earphone plug is insertable; an audio module that processes a sound signal; a first circuit that connects the audio module with a first terminal of the earphone plug; a second circuit that connects the audio module with a second terminal of the earphone plug; a switch that connects the first circuit with the second circuit; and a processor that performs control to output a first signal from the audio module through the second circuit when the earphone plug is inserted into the connector, and determines a type of the earphone plug inserted into the connector based on whether the output first signal is received by the audio module through the switch and the first circuit.

According to one exemplary embodiment, the first terminal of the earphone plug may be either of a ground terminal or a microphone terminal of the earphone plug.

According to one exemplary embodiment, the second terminal of the earphone plug may be either of a left earphone speaker terminal or a right earphone speaker terminal of the earphone plug.

According to one exemplary embodiment, the processor may perform control so that the switch does not connect the first circuit with the second circuit when the type of earphone plug is determined.

According to one exemplary embodiment, the type of earphone plug may be either of a 3-pole earphone plug or a 4-pole earphone plug.

According to one exemplary embodiment, the processor may determine that the type of earphone plug inserted into the connector is a 3-pole earphone plug when the output first signal is not received by the audio module through the switch and the first circuit.

According to one exemplary embodiment, the processor may determine that the type of earphone plug inserted into the connector is a 4-pole earphone plug when the output first signal is received by the audio module through the switch and the first circuit.

According to one exemplary embodiment, the first signal may be an earphone recognition signal having a designated frequency. According to one exemplary embodiment, the first signal may be a signal having a frequency in an inaudible band.

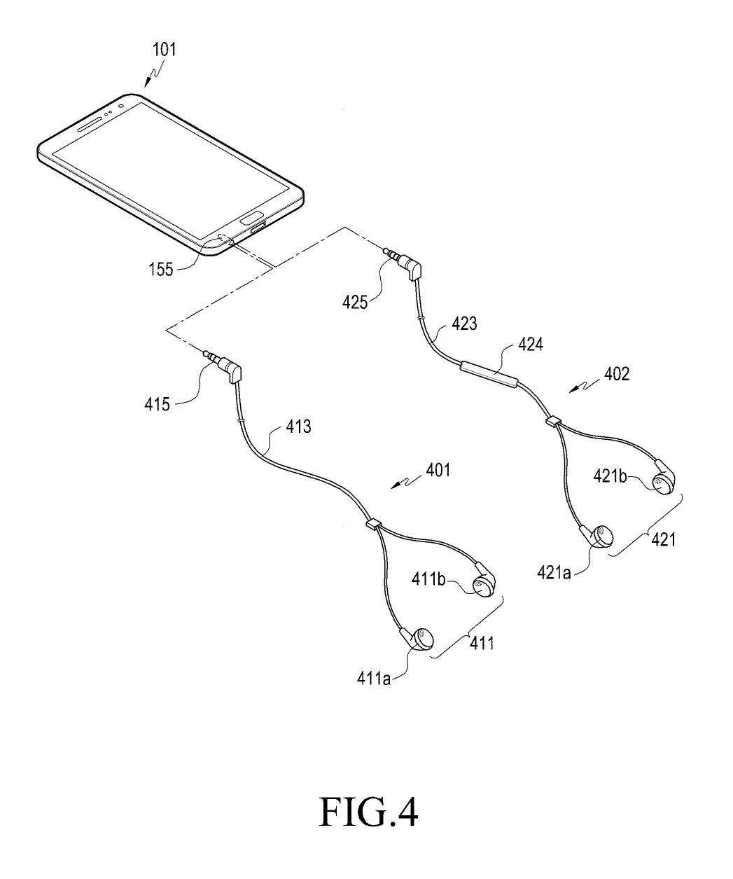

FIG. 4 schematically illustrates the configuration of an electronic device and earphones connected with the electronic device according to various exemplary embodiments.

Referring to FIG. 4, the electronic device 101 may perform a sound input/output function. The electronic device 101 may include a speaker and a microphone. The electronic device 101 may output a call voice or a sound signal (music, a movie sound, or the like) related to media output through the speaker. Further, the electronic device 101 may receive a user voice or an external sound signal through the microphone. The electronic device 101 may output a sound signal or may receive an ambient sound signal through connection with an external sound input/output device (for example, earphones, a headset, or the like).

According to various exemplary embodiments, when an external sound input/output device is inserted into a connection member 155, the electronic device 101 may output a frequency signal designated for earphone recognition through an EAR SPK port of a processor or an audio module included in the electronic device 101. The electronic device 101 may recognize whether the external sound input/output device inserted into the connection member 155 is first earphones 401 having a 3-pole earphone plug 415 or second earphones 402 having a 4-pole earphone plug 425 according to whether the designated frequency signal output through the EAR SPK port is received through an EAR MIC port of the processor or the audio module. According to various exemplary embodiments, when the designated frequency signal output through the EAR SPK port is not received through the EAR MIC port, the electronic device 101 may recognize the external sound input/output device, inserted into the connection member 155, as the first earphones 401 having the 3-pole earphone plug 415. When the designated frequency signal output through the EAR SPK port is received through the EAR MIC port or a signal similar to the designated frequency signal output through the EAR SPK port is received through the EAR MIC port, the electronic device 101 may recognize the external sound input/output device, inserted into the connection member 155, as the second earphones 402 having the 4-pole earphone plug 425.

According to one exemplary embodiment, a certain frequency range may be used as a criterion for determining whether a signal received through the EAR MIC port is similar to the designated frequency signal. The certain frequency range may be a range including the frequency of the designated frequency signal. When the frequency of a signal received through the EAR MIC port is within the certain frequency range, the electronic device 101 may determine that the signal received through the EAR MIC port is similar to the designated frequency signal.

The first earphones 401 may include an ear speaker 411, a connection portion 413, and the 3-pole earphone plug 415. The ear speaker 411 may convert an electrical signal for sound output into a sound, and may output the sound. The ear speaker 411 may include a left ear speaker 411a and a right ear speaker 411b. A user may hear a sound output from the electronic device 101 by placing the left ear speaker 411a and the right ear speaker 411b into the ears. The connection portion 413 may connect components of the first earphones 401 in between. The connection portion 413 may include a conducting wire to transmit an electrical signal internally. The 3-pole earphone plug 415 may be inserted into the connection member 155 to be connected to the electronic device 101.

The second earphones 402 may include an ear speaker 421, a connection portion 423, an ear microphone 424, and the 4-pole earphone plug 425. The ear speaker 421 may convert an electrical signal for sound output into a sound and may output the sound. The ear speaker 421 may include a left ear speaker 421a and a right ear speaker 421b. A user may hear a sound output from the electronic device 101 by placing the left ear speaker 421a and the right ear speaker 421b into the ears. The connection portion 423 may connect components of the second earphones 402 in between. The connection portion 423 may include a conducting wire to transmit an electrical signal internally. The ear microphone 424 may receive an ambient sound signal. The ear microphone 424 may be disposed at a certain distance (for example, 15 cm to 20 cm) from the ear speaker 421. The ear microphone 424 may be disposed at a position corresponding to the position of the user's mouth when the user places the ear speaker 421 into the ears. The 4-pole earphone plug 425 may be inserted into the connection member 155 to be connected to the electronic device 101. The connection member 155 may be a connector including a plurality of terminals.

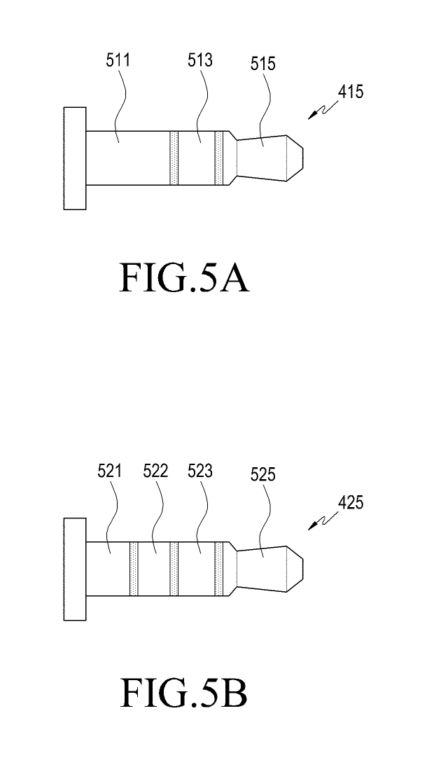

FIGS. 5A and 5B illustrate examples of an earphone plug structure according to various exemplary embodiments. Referring to FIGS. 5A and 5B, an earphone plug may be formed to have the structure of a 3-pole earphone plug 415 shown in FIG. 5A or to have the structure of a 4-pole earphone plug 425 shown in FIG. 5B.

Referring to FIG. 5A, the 3-pole earphone plug 415 may have the form of a 3-pole terminal. The 3-pole terminal may include a ground (or GND) terminal 511, a first sound terminal 513, and a second sound terminal 515. The first sound terminal 513 and the second sound terminal 515 may be a left ear speaker terminal (EAR SPK L) and a right ear speaker terminal (EAR SPK R), respectively.

Referring to FIG. 5B, the 4-pole earphone plug 425 may take the form of a 4-pole terminal. The 4-pole terminal may include a ground (or GND) terminal 521, a microphone (MIC) terminal 522, a first sound terminal 523, and a second sound terminal 525. The first sound terminal 523 and the second sound terminal 525 may be a left ear speaker terminal (EAR SPK L) and a right ear speaker terminal (EAR SPK R), respectively.

When the 3-pole earphone plug 415 or the 4-pole earphone plug 425 is inserted into the connection member 155 of the electronic device 101, interruption (for example, insertion interruption) may occur due to contact between the terminals of the 3-pole earphone plug 415 or the 4-pole earphone plug 425 and terminals in the connection member 155. Insertion interruption may be used as a start signal to start an operation of recognizing the type of earphone plug inserted into the electronic device 101.

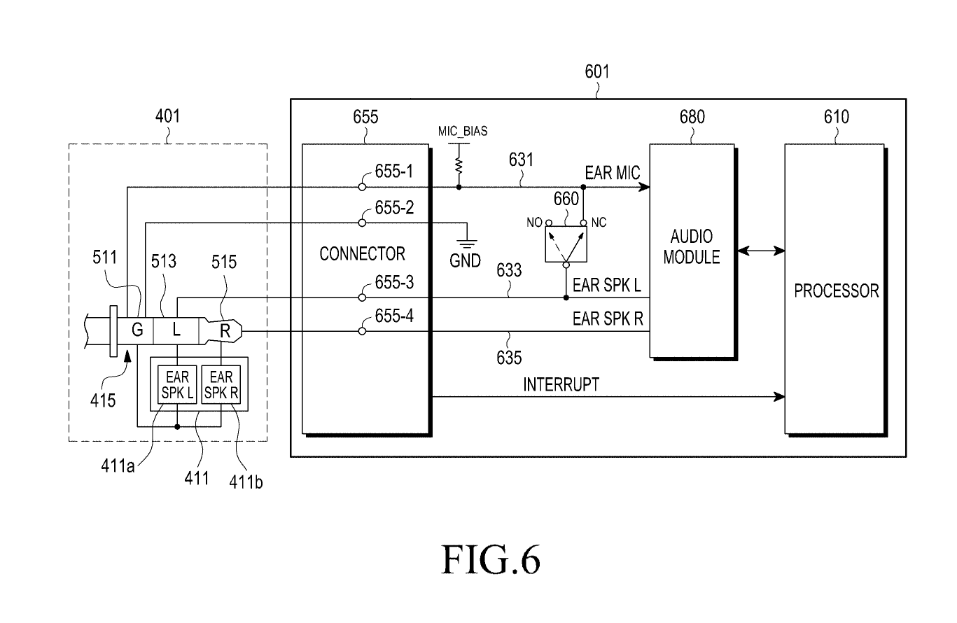

FIG. 6 illustrates a block diagram of the configuration of 3-pole earphones and an electronic device according to various exemplary embodiments.

Referring to FIG. 6, the electronic device 601 may include a connector 655, a switch 660, an audio module 680, and a processor 610. These elements are functional elements, some of which may be physically integrated or separated. For example, the audio module 680 may be included as part of the processor 610, or may be integrated with the processor 610.

The connector 655 may include a plurality of connection terminals. The plurality of connection terminals may be configured to correspond both to a 3-pole earphone plug and to a 4-pole earphone plug. The plurality of connection terminals may include first to fourth connection terminals 655-1 to 655-4.

The electronic device 601 may include a first circuit 631 connecting an EAR MIC port of the audio module 680 with a ground terminal 511 of an earphone plug 415, a circuit 633 connecting an EAR SPK L port of the audio module 680 with a left earphone speaker terminal 513 of the earphone plug 415, and a circuit 635 connecting an EAR SPK R port of the audio module 680 with a right earphone speaker terminal 515 of the earphone plug 415. Any one of the circuit 633 connecting the EAR SPK L port of the audio module 680 with the left earphone speaker terminal 513 of the earphone plug 415 and the circuit 635 connecting the EAR SPK R port of the audio module 680 with the right earphone speaker terminal 515 of the earphone plug 415 may be a second circuit.

The switch 660 may connect the first circuit 631 and the second circuit 633 or 635. For example, the switch 660 may connect a conductive line connected to the EAR MIC port of the audio module 680 and a conductive line connected to the EAR SPK R port, or may connect the conductive line connected to the EAR MIC port of the audio module 680 and a conductive line connected to the EAR SPK L port. When the switch 660 connects the conductive line connected to the EAR MIC port of the audio module 680 and the conductive line connected to the EAR SPK R port, the switch 660 may perform a switching operation of connecting the conductive line connected to the EAR MIC port and the conductive line connected to the EAR SPK L port or of disconnecting the conductive line connected to the EAR MIC port from the conductive line connected to the EAR SPK L port. According to various exemplary embodiments, the switch 660 may perform a Normal Close (NC) operation of connecting the conductive line connected to the EAR MIC port and the conductive line connected to the EAR SPK L port in the default state, while the switch 660 may perform a Normal Open (NO) operation of disconnecting the conductive line connected to the EAR MIC port from the conductive line connected to the EAR SPK L port when the determination of the type of inserted earphones is completed.

Although not shown, when the switch 660 connects the conductive line connected to the EAR MIC port of the audio module 680 and the conductive line connected to the EAR SPK L port, the switch 660 may perform a switching operation of connecting the conductive line connected to the EAR MIC port and the conductive line connected to the EAR SPK R port or of disconnecting the conductive line connected to the EAR MIC port from the conductive line connected to the EAR SPK R port. According to various exemplary embodiments, the switch 660 may perform an NC operation of connecting the conductive line connected to the EAR MIC port with the conductive line connected to the EAR SPK R port in the default state, while the switch 660 may perform an NO operation of disconnecting the conductive line connected to the EAR MIC port from the conductive line connected to the EAR SPK R port when the determination of the type of inserted earphones is completed.

The audio module 680 may perform signal conversion, data processing, and the like for input and output of a sound signal. The audio module 680 may convert a sound to be output to an ear speaker into an electrical signal or a signal in a predetermined format, or may convert a sound received from an ear microphone into an electrical signal or a signal in a predetermined format. The audio module 680 may provide a converted signal to the processor 610 or may receive and process a control signal or a sound signal from the processor 610. According to various exemplary embodiments, the audio module 680 may include the EAR MIC port, the EAR SPK R port, and the EAR SPK L port. The audio module 680 may convert a sound, received through the EAR MIC port, into an electrical signal or a signal in a predetermined format. The audio module 680 may convert a sound to be output into an electrical signal or a signal in a predetermined format and may output the signal through each of the EAR SPK R port and the EAR SPK L port.

According to various exemplary embodiments, when the 3-pole earphone plug 415 is inserted into the connector 655, a ground (or GND) terminal 511 may be connected to the EAR MIC port of the audio module 680 through the first connection terminal 655-1 of the connector 655, and may be connected to a GND of the electronic device 601 through the second connection terminal 655-2 of the connector 655. A left ear speaker terminal (EAR SPK L) 411a may be connected to the EAR SPK L port of the audio module 680 through the third connection terminal 655-3 of the connector 655. A right ear speaker terminal (EAR SPK R) 411b may be connected to the EAR SPK R port of the audio module 680 through the fourth connection terminal 655-4 of the connector 655.

According to various exemplary embodiments, when the 3-pole earphone plug 415 is inserted into the connector 655, insertion interruption may occur due to contact between the terminals of the 3-pole earphone plug 415 and the terminals of the connector 655. Insertion interruption may be used as a start signal to start an operation of recognizing the type of earphones inserted into the electronic device 601. The connector 655 may provide a signal relating to insertion interruption to the processor 610.

When insertion interruption occurs, the processor 610 may output a predetermined earphone recognition signal through the audio module 680. According to various exemplary embodiments, when the switch 660 connects the EAR MIC port of the audio module 680 and the EAR SPK L port, the processor 610 may perform control to output the earphone recognition signal through the EAR SPK L port. When the switch 660 connects the EAR MIC port of the audio module 680 and the EAR SPK R port, the processor 610 may perform control to output the earphone recognition signal through the EAR SPK R port. According to various exemplary embodiments, the earphone recognition signal may be a signal having a designated frequency. The signal having the designated frequency may be a signal having a frequency in an inaudible band. The designated frequency may be a frequency previously agreed upon by electronic device manufacturers for use as an earphone recognition signal.

When the switch 660 connects the EAR MIC port and the EAR SPK L port of the audio module 680, the earphone recognition signal output from the EAR SPK L port of the audio module 680 may be received by the EAR MIC port connected through the switch 660. When the switch 660 connects the EAR MIC port and the EAR SPK R port of the audio module 680, the earphone recognition signal output from the EAR SPK R port of the audio module 680 may be received by the EAR MIC port connected through the switch 660.

The audio module 680 may transmit a signal received by the EAR MIC port to the processor 610. The processor 610 or the audio module 680 may compare the signal received by the EAR MIC port with the output earphone recognition signal, and may determine that the type of earphones inserted into the electronic device 601 is first earphones 401 having the 3-pole earphone plug 415 when no signal is received by the EAR MIC port or when the signal received by the EAR MIC port is dissimilar from the output earphone recognition signal. When the signal received by the EAR MIC port is similar to the output earphone recognition signal, the processor 610 may determine that the type of earphones inserted into the electronic device 601 is second earphones 402 having a 4-pole earphone plug 425. According to one exemplary embodiment, the processor 610 may use a certain frequency range as a criterion for determining whether the signal received by the EAR MIC port is similar to the earphone recognition signal. The certain frequency range may be a range including the frequency of the earphone recognition signal. When the signal received by the EAR MIC port is within the certain frequency range, the electronic device 601 may determine that the signal received by the EAR MIC port is similar to the earphone recognition signal.

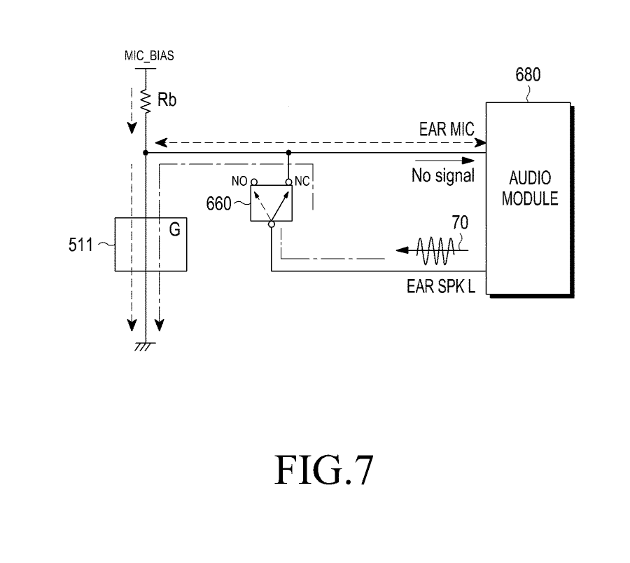

FIG. 7 illustrates a circuit diagram for explaining the principle whereby, when a 3-pole earphone plug 415 is inserted, an earphone recognition signal output from an EAR SPK L port of an audio module 680 is not received by an EAR MIC port connected through a switch 660 according to various exemplary embodiments.

Referring to FIG. 7, when the 3-pole earphone plug 415 is inserted into a connector 655, the EAR MIC port is connected to a ground (or GND) terminal 511 of the 3-pole earphone plug. Accordingly, the voltage value of the MIC port may be fixed to a ground value, which is 0 V. Accordingly, a predetermined earphone recognition signal 70 output from the EAR SPK L port connected to the EAR MIC port through the switch 660 may also be changed to 0 V, and thus a signal corresponding to the earphone recognition signal 70 may disappear.

Therefore, when the 3-pole earphone plug 415 is inserted into the connector 655, the predetermined earphone recognition signal 70 output from the EAR SPK L port may not be received at the EAR MIC port, and the EAR MIC port receives no signal or receives a noise signal due to a ground. Accordingly, a processor 610 may compare the signal received by the EAR MIC port with the output earphone recognition signal, and may determine that the type of earphones inserted into the electronic device 601 is first earphones 401 having the 3-pole earphone plug 415 when the output earphone recognition signal is not received by the EAR MIC port. Alternatively, the processor 610 may compare the signal received by the EAR MIC port with the output earphone recognition signal, and may determine that the type of earphones inserted into the electronic device 601 is the first earphones 401 having the 3-pole earphone plug 415 when the signal received by the EAR MIC port is dissimilar from the output earphone recognition signal. According to one exemplary embodiment, the processor 610 may use a certain frequency range as a criterion for determining whether the signal received by the EAR MIC port is similar to the earphone recognition signal. The certain frequency range may be a range that includes the frequency of the earphone recognition signal. When the signal received by the EAR MIC port is within the certain frequency range, the electronic device 601 may determine that the signal received by the EAR MIC port is similar to the earphone recognition signal.

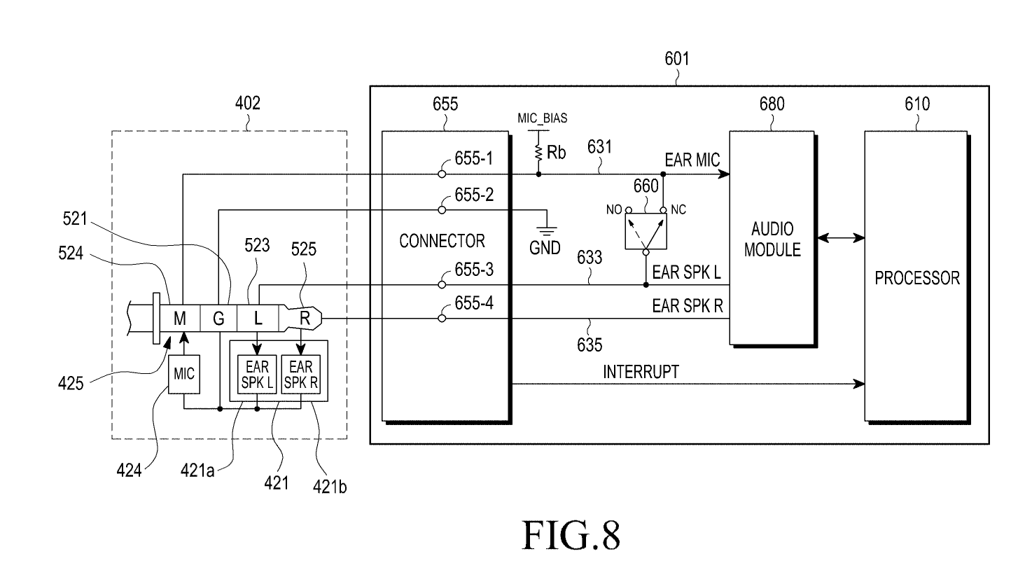

FIG. 8 illustrates a block diagram of the configuration of 4-pole earphones and an electronic device according to various exemplary embodiments.

Referring to FIG. 8, the electronic device 601 may include a connector 655, a switch 660, an audio module 680, and a processor 610. The configuration and operation of the electronic device 601 may be the same as those described in FIG. 6.

According to various embodiments, when a 4-pole earphone plug 425 is inserted into the connector 655, a microphone (M) terminal 524 may be connected to an EAR MIC port of the audio module 680 through a first connection terminal 655-1 of the connector 655. A ground (or G) terminal 521 may be connected to a GND of the electronic device 601 through the second connection terminal 655-2 of the connector 655. A left ear speaker terminal (EAR SPK L) 421a may be connected to an EAR SPK L port of the audio module 680 through a third connection terminal 655-3 of the connector 655. A right ear speaker terminal (EAR SPK R) 421b may be connected to an EAR SPK R port of the audio module 680 through a fourth connection terminal 655-4 of the connector 655.

According to various exemplary embodiments, the electronic device 601 may include a first circuit 631 connecting the EAR MIC port of the audio module 680 and the microphone terminal 524, a circuit 633 connecting the EAR SPK L port of the audio module 680 with a left earphone speaker terminal 523 of the earphone plug 425, and a circuit 635 connecting the EAR SPK R port of the audio module 680 with a right earphone speaker terminal 525 of the earphone plug 425. Any one of the circuit 633 connecting the EAR SPK L port with the left earphone speaker terminal 523 of the earphone plug 425 and the circuit 635 connecting the EAR SPK R port with the right earphone speaker terminal 525 of the earphone plug 425 may be a second circuit. The switch 660 may connect the first circuit 631 and the second circuit 633 or 635.

According to various exemplary embodiments, when the 4-pole earphone plug 425 is inserted into the connector 655, insertion interruption may occur due to contact between the terminals of the 4-pole earphone plug 425 and the terminals of the connector 655. Insertion interruption may be used as a start signal to start an operation of recognizing the type of earphones inserted into the electronic device 601. The connector 655 may provide a signal relating to insertion interruption to the processor 610.

When insertion interruption occurs, the processor 610 may output a predetermined earphone recognition signal through the audio module 680. According to various exemplary embodiments, when the switch 660 connects a conductive line connected to the EAR MIC port of the audio module 680 and a conductive line connected to the EAR SPK L port, the processor 610 may output the earphone recognition signal through the EAR SPK L port. When the switch 660 connects the conductive line connected to the EAR MIC port of the audio module 680 and a conductive line connected to the EAR SPK R port, the processor 610 may output the earphone recognition signal through the EAR SPK R port. According to various exemplary embodiments, the earphone recognition signal may be a signal having a designated frequency. The signal having the designated frequency may be a signal having a frequency in an inaudible band.

When the switch 660 connects the conductive line connected to the EAR MIC port of the audio module 680 and the conductive line connected to the EAR SPK L port, the earphone recognition signal output from the EAR SPK L port of the audio module 680 may be received by the EAR MIC port connected through the switch 660. When the switch 660 connects the conductive line connected to the EAR MIC port of the audio module 680 and the conductive line connected to the EAR SPK R port, the earphone recognition signal output from the EAR SPK port of the audio module 680 may be received by the EAR MIC port connected through the switch 660.

The audio module 680 may transmit a signal received by the EAR MIC port to the processor 610. The processor 610 or the audio module 680 may compare the signal received by the EAR MIC port with the output earphone recognition signal, and may determine that the type of earphones inserted into the electronic device 601 is first earphones 401 having a 3-pole earphone plug 415 when the output earphone recognition signal is not received by the EAR MIC port. Alternatively, the processor 610 may compare the signal received by the EAR MIC port with the output earphone recognition signal, and may determine that the type of the earphones inserted into the electronic device 601 is the first earphones 401 having the 3-pole earphone plug 415 when the signal received by the EAR MIC port is dissimilar from the output earphone recognition signal. When the signal received by the EAR MIC port is similar to the output earphone recognition signal, the processor 610 may determine that the type of the earphones inserted into the electronic device 601 is second earphones 402 having the 4-pole earphone plug 425. According to one exemplary embodiment, the processor 610 may use a certain frequency range as a criterion for determining whether the signal received by the EAR MIC port is similar to the earphone recognition signal. The certain frequency range may be a range including the frequency of the earphone recognition signal. When the signal received by the EAR MIC port is within the certain frequency range, the electronic device 601 may determine that the signal received by the EAR MIC port is similar to the earphone recognition signal.

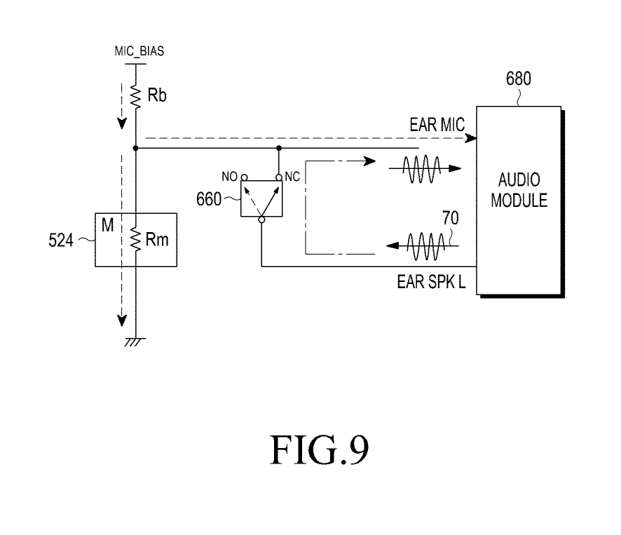

FIG. 9 illustrates a circuit diagram for explaining the principle whereby, when a 4-pole earphone plug 425 is inserted, an earphone recognition signal output from an EAR SPK L port of an audio module 680 is received by an EAR MIC port connected through a switch 660 according to various exemplary embodiments.

Referring to FIG. 9, when the 4-pole earphone plug 425 is inserted into a connector 655, a voltage of a specific voltage value is applied to an EAR MIC port by MIC_BIAS, Rb, and the equivalent resistance Rm of a microphone terminal 524 of the 4-pole earphone plug 425, which are connected to the EAR MIC port. Accordingly, a predetermined earphone recognition signal 70, output from an EAR SPK L, also flows to the EAR MIC port through a switch 660. Therefore, when the 4-pole earphone plug 425 is inserted into the connector 655, the predetermined earphone recognition signal 70, output from the EAR SPK L, may be received by the EAR MIC port. According to this principle, a processor 610 may compare a signal received by the EAR MIC port with the output earphone recognition signal, and may determine that the type of earphones inserted into the electronic device 601 is second earphones 402 having the 4-pole earphone plug 425 when the signal received by the EAR MIC port is similar to the output earphone recognition signal. According to one exemplary embodiment, the processor 610 may use a certain frequency range as a criterion for determining whether the signal received by the EAR MIC port is similar to the earphone recognition signal. The certain frequency range may be a range including the frequency of the earphone recognition signal. When the signal received by the EAR MIC port is within the certain frequency range, the electronic device 601 may determine that the signal received by the EAR MIC port is similar to the earphone recognition signal.

According to various exemplary embodiments, in a method for recognizing an earphone plug, an electronic device may perform: connecting a first circuit, which connects an audio module with a first terminal of an earphone plug, with a second circuit, which connects the audio module with a second terminal of the earphone plug; outputting a first signal from the audio module through the second circuit when the earphone plug is inserted into a connector; and determining a type of the earphone plug inserted into the connector based on whether the output first signal is received by the audio module through a switch and the first circuit.

According to one exemplary embodiment, the electronic device may further perform disconnecting the first circuit from the second circuit when the type of the earphone plug is determined.

According to one exemplary embodiment, the type of the earphone plug may be either of a 3-pole earphone plug or a 4-pole earphone plug.

According to one exemplary embodiment, the determining of the type of the earphone plug may include determining that the type of the earphone plug inserted into the connector is a 3-pole earphone plug when the output first signal is not received by the audio module through the switch and the first circuit.

According to one exemplary embodiment, the determining of the type of the earphone plug may include determining that the type of the earphone plug inserted into the connector is a 4-pole earphone plug when the output first signal is received by the audio module through the switch and the first circuit.

According to one exemplary embodiment, the first signal may be an earphone recognition signal having a designated frequency. According to one exemplary embodiment, the first signal may be a signal having a frequency in an inaudible band.

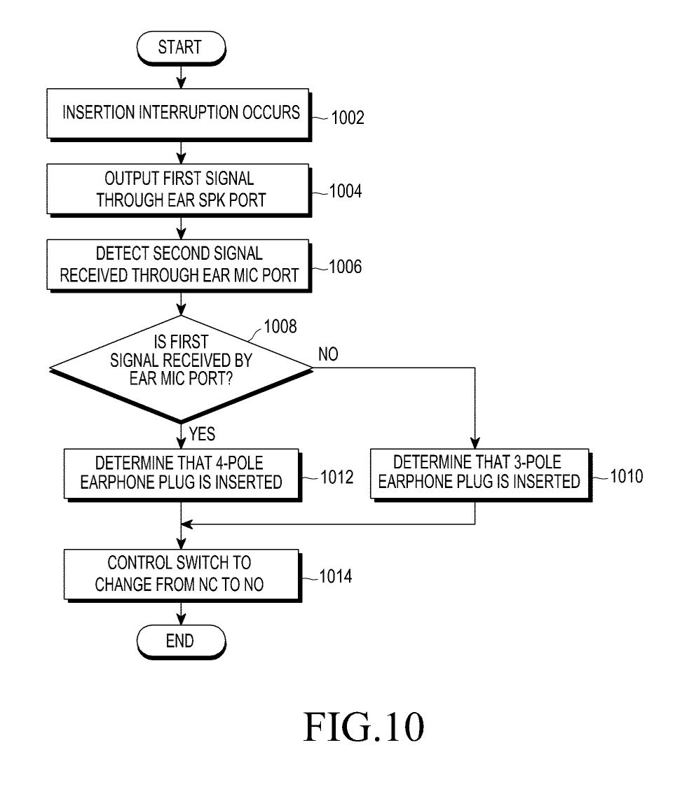

FIG. 10 illustrates a flowchart of an operation of recognizing an earphone plug type according to various exemplary embodiments.

Referring to FIG. 10, in operation 1002, an electronic device may undergo insertion interruption when first earphones 401 or second earphones 402 are inserted into a connector 655.

When insertion interruption occurs, the electronic device may output a first signal through an EAR SPK port in operation 1004. According to various exemplary embodiments, the electronic device may output the first signal through either an EAR SPK L port or an EAR SPK R port. The first signal may be an earphone recognition signal. According to various exemplary embodiments, the earphone recognition signal may be a signal having a designated frequency. The signal having the designated frequency may be a signal having a frequency in an inaudible band.

According to various exemplary embodiments, when a 3-pole earphone plug 415 is inserted into the connector 655, the first signal, output from the EAR SPK L port or the EAR SPK R port, may not be received by an EAR MIC port, and the EAR MIC port may receive no signal, or may receive a second signal (for example, a noise signal due to a ground). When a 4-pole earphone plug 425 is inserted into the connector 655, the first signal, output from the EAR SPK L port or the EAR SPK R port, may be received as a second signal by the EAR MIC port.

In operation 1006, the electronic device may detect the second signal received through the EAR MIC port. In operation 1008, the electronic device may determine whether the first signal is received by the EAR MIC port. According to various exemplary embodiments, when no signal is received by the EAR MIC port, or when the second signal received by the EAR MIC port is dissimilar from the output first signal as a result of comparing the second signal received by the EAR MIC port with the output first signal, the electronic device may determine that the first signal is not received by the EAR MIC port.

When no signal is received by the EAR MIC port or the second signal received by the EAR MIC port is dissimilar from the output first signal, the electronic device may determine in operation 1010 that the type of earphones inserted into the electronic device is the first earphones 401 having the 3-pole earphone plug 415.

When the second signal received by the EAR MIC port is similar to the output first signal as a result of comparing the second signal received by the EAR MIC port with the output first signal, the electronic device may determine in operation 1012 that the type of earphones inserted into the electronic device is the second earphones 402 having the 4-pole earphone plug 425. According to one exemplary embodiment, the electronic device may use a certain frequency range as a criterion for determining whether the received second signal is similar to the first signal. The certain frequency range may be a range including the frequency of the first signal. When the second signal received by the EAR MIC port is within the certain frequency range, the electronic device may determine that the second signal received by the EAR MIC port is similar to the first signal.

When the type of earphones is determined, the electronic device may control a switch to change from an NC state to an NO state in operation 1014. That is, the electronic device may control the switch to change from the NC state, in which the switch connects the EAR MIC port with the EAR SPK R port or the EAR SPK L port, to the NO state, in which the switch does not connect the EAR MIC port with the EAR SPK R port or the EAR SPK L port. In the NO state, the electronic device may transmit and receive an audio signal through the inserted earphones.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

According to various exemplary embodiments, a storage medium stores an earphone plug recognition program, wherein the program may perform, in an electronic device: connecting a first circuit, which connects an audio module with a first terminal of an earphone plug, with a second circuit, which connects the audio module with a second terminal of the earphone plug; outputting a first signal from the audio module through the second circuit when the earphone plug is inserted into a connector; and determining the type of the earphone plug inserted into the connector based on whether the output first signal is received by the audio module through a switch and the first circuit.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a connector into which an earphone plug is insertable;
an audio module configured to process a sound signal;
a first circuit configured to connect the audio module with a first terminal of the earphone plug;
a second circuit configured to connect the audio module with a second terminal of the earphone plug;
a switch configured to connect the first circuit with the second circuit; and
a processor configured to perform control to output a first signal from the audio module through the second circuit when the earphone plug is inserted into the connector, and configured to determine a type of the earphone plug inserted into the connector based on whether the output first signal is received by the audio module through the switch and the first circuit.

2. The electronic device of claim 1, wherein the first terminal of the earphone plug is a ground terminal of the earphone plug.

3. The electronic device of claim 1, wherein the first terminal of the earphone plug is a microphone terminal of the earphone plug.

4. The electronic device of claim 1, wherein the second terminal of the earphone plug is a left earphone speaker terminal of the earphone plug.

5. The electronic device of claim 1, wherein the second terminal of the earphone plug is a right earphone speaker terminal of the earphone plug.

6. The electronic device of claim 1, wherein the processor controls the switch to not connect the first circuit with the second circuit when the type of the earphone plug is determined.

7. The electronic device of claim 1, wherein the type of the earphone plug is either a 3-pole earphone plug or a 4-pole earphone plug.

8. The electronic device of claim 7, wherein the processor is further configured to determine that the type of the earphone plug inserted into the connector is a 3-pole earphone plug when the output first signal is not received by the audio module through the switch and the first circuit.

9. The electronic device of claim 7, wherein the processor is further configured to determine that the type of the earphone plug inserted into the connector is a 4-pole earphone plug when the output first signal is received by the audio module through the switch and the first circuit.

10. The electronic device of claim 1, wherein the first signal is an earphone recognition signal having a designated frequency.

11. The electronic device of claim 10, wherein the first signal is a signal having a frequency in an inaudible band.

12. A method for recognizing an earphone plug by an electronic device, the method comprising:
connecting a first circuit, which connects an audio module with a first terminal of an earphone plug, with a second circuit, which connects the audio module with a second terminal of the earphone plug;
outputting a first signal from the audio module through the second circuit when the earphone plug is inserted into a connector; and
determining a type of the earphone plug inserted into the connector based on whether the output first signal is received by the audio module through a switch and the first circuit.

13. The method of claim 12, further comprising disconnecting the first circuit from the second circuit when the type of the earphone plug is determined.

14. The method of claim 12, wherein the type of the earphone plug is either a 3-pole earphone plug or a 4-pole earphone plug.

15. The method of claim 14, wherein the determining of the type of the earphone plug includes determining that the type of the earphone plug inserted into the connector is a 3-pole earphone plug when the output first signal is not received by the audio module through the switch and the first circuit.

16. The method of claim 14, wherein the determining of the type of the earphone plug includes determining that the type of the earphone plug inserted into the connector is a 4-pole earphone plug when the output first signal is received by the audio module through the switch and the first circuit.

17. The method of claim 12, wherein the first signal is an earphone recognition signal having a designated frequency.

18. The method of claim 17, wherein the first signal is a signal having a frequency in an inaudible band.

19. The method of claim 17, wherein the determining of the type of the earphone plug includes determining that the designated frequency of the earphone recognition signal is within a certain frequency range.

20. A storage medium that stores an earphone plug recognition program, the program configured to perform, in an electronic device, a plurality of operations, the plurality of operations comprising:
connecting a first circuit, which connects an audio module with a first terminal of an earphone plug, with a second circuit, which connects the audio module with a second terminal of the earphone plug;
outputting a first signal from the audio module through the second circuit when the earphone plug is inserted into a connector; and
determining a type of the earphone plug inserted into the connector based on whether the output first signal is received by the audio module through a switch and the first circuit.
